(19) United States
(12) Patent Application Publication
(10) Pub. No.: US 2005/0276729 A1
(43) Pub. Date: Dec. 15, 2005

(54) Sample collection container rack overlays

(76) Inventor: Alan W. Helt, Waunakee, WI (US)

Correspondence Address: FOLEY & LARDNER, 150 EAST GILMAN STREET, P.O. BOX 1497, MADISON, WI, 53701-1497, US

(21) Appl. No.: 11/148,972

(22) Filed: Jun. 9, 2005

Related U.S. Application Data
(60) Provisional application No. 60/578,551, filed on Jun. 10, 2004.

(51) Int. Cl. B01L 3/00

(52) U.S. Cl. 422/102; 422/63

(57) ABSTRACT

A sample collection container rack overlay comprising a top with apertures and identifying marks identifying the apertures and at least one projecting side is provided. The sample collection container overlay rack is adapted to fit sample collection container racks and provide ease of identification of sample collection containers present in the sample collection container racks. The apertures of the sample collection container rack may include any size adapted to receive sample collection containers. The at least one projecting side provides added stability to the sample collection container rack overlay. Additionally the at least one projecting side may include a knurled portion or a finger indentation for ease of placements and of removal of the rack overly from the rack.

### FIELD OF THE INVENTION

The present invention relates to devices for identifying scientific samples contained in sample collection container racks or holders, including devices for identifying scientific samples collected during automated liquid handling.

### DESCRIPTION

The use of sample collection container racks or holders to hold test tubes and various other types of sample collection containers, such as microcentrifuge tubes, is well known in the art. In the art, the sample collection container racks and holders have many different sizes and different sample collection container capacities.

Sample collection container numbered rack overlays, which fit over the sample collection container racks and holder, are also known in the art. However, previously known rack overlays exhibit various problems. For example, some rack overlays lack projecting sides. Furthermore, the known rack overlays are made out of a thicker gage steel making them heavier and more likely to chip the glass test tubes. The lack of projecting sides allows the overlay to shift when it is laid on the sample collection container rack. This potentially causes problems when sample collection container racks are moved from one area to another, a practice common in a laboratory setting. Furthermore, since the known rack overlays do not have an anchor such as a projecting side, displacement of the rack overlay can contact the sample collection container, theoretically with enough force to cause breakage. Additionally, without a projecting side, the rack overlay may be difficult to grasp for removal particularly when the hand is gloved as in some laboratory settings.

Because of the lack of stability, and thus, the potential for displacing the rack overlay, as well as the need to remove the sample collection container rack overlay, users need an improved sample collection container rack overlay, which provides the advantages of easy sample identification without the disadvantages associated with known sample collection container rack overlays and the advantage of easy removal of the overlay.

### SUMMARY

The invention relates to an improved device for identifying sample collection containers on a sample collection container rack. More specifically, the invention relates to identifying sample collection containers in sample collection container racks used with automated liquid handlers through use of a sample collection container rack overlay with a top containing apertures and identifying marks that identify the apertures. The sample collection container rack overlays have at least one projecting side for aligning the overlay with the sample collection container rack and/or securing the overlay to the rack. At least a portion of an edge of the at least one projecting side may be knurled to facilitate grasping and removal of the overlay from the rack.

Although the sample collection container rack overlays of the present invention are not limited to use with automated liquid handlers, in one aspect of the invention the sample collection container rack overlays allow users to quickly and easily locate specific samples or collected fractions on a sample collection container rack on the bed of an automated liquid handler by matching the identifying marks from the sample tracking capabilities of the system software to the actual on-bed sample collection identifying mark locations on the sample collection container rack overlay. This capability dramatically speeds up the process of finding targeted fractions, which saves end user time and cost and reduces the potential for user error.

Individual embodiments of the invention offer valuable advantages and benefits over the prior art. For example, the use of a sample collection container rack overlay with at least one projecting side prevents the sample collection container rack overlay from sliding off when sample collection containers are not present in the sample collection container rack. Embodiments of the present invention also allow storage and stacking of the sample collection container racks without having to risk slippage of the sample collection container rack overlay if it is not removed. Embodiments additionally provide for easy removal of the overlay from the rack. These and other advantages will be apparent through the following detailed description of an exemplary invention embodiment.

### BRIEF DESCRIPTION OF THE DRAWINGS

The preferred exemplary embodiment of the invention will hereinafter be described in conjunction with the appended drawings, wherein like numerals denote like elements.

FIG. 1 is a perspective view of a sample collection container rack overlay according to an exemplary embodiment, wherein the sample collection container rack overlay comprises four projecting sides and a top with circular openings and decimal numbering.

FIGS. 2a, 2b, and 2c are perspective views of several embodiments demonstrating a variety of different sized circular openings.

FIGS. 3a and 3b are schematic diagrams demonstrating a sample collection container rack overlay with serpentine decimal numbering (3a) or non-serpentine decimal numbering (3b), where the numbering of the sample collection container rack overlay starts at the back left of the top.

FIGS. 4a, 4b, 4c, and 4d are perspective views of various embodiments showing different shapes of the projecting sides of the rack count overlay.

FIG. 5 is a perspective view of an embodiment which demonstrates at least one projecting side of the sample collection container rack overlay spanning approximately one-half the length of the top.

FIG. 6 is a perspective view of an exemplary sample collection container rack overlay on a sample collection container rack.

### DETAILED DESCRIPTION OF EXEMPLARY EMBODIMENTS

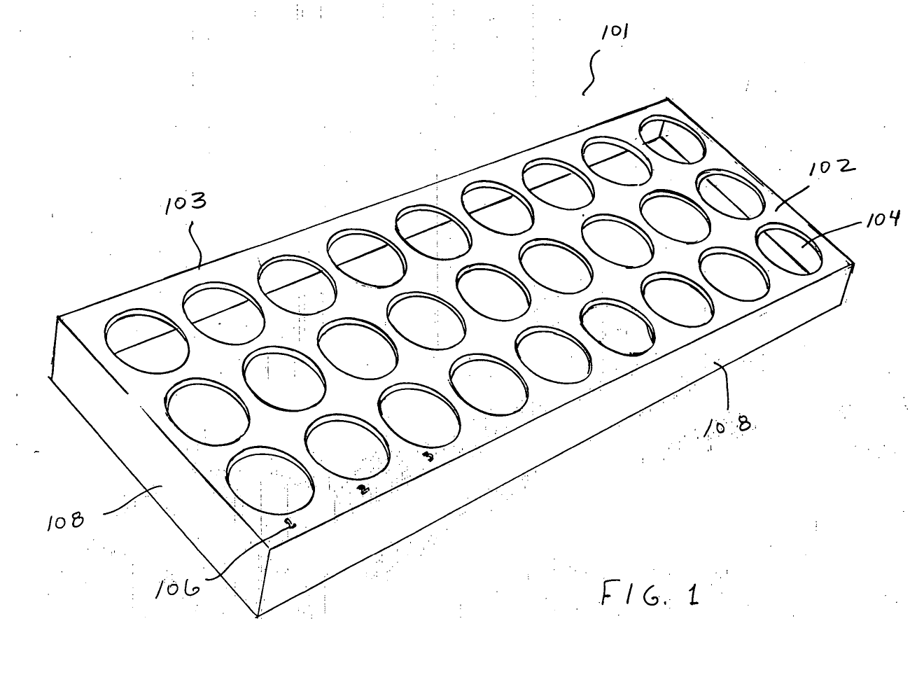

In reference to the drawings, FIG. 1 shows a perspective view of an exemplary sample collection container rack overlay 101. Specifically, in the exemplary embodiment of FIG. 1, the components of the sample collection container rack overlay include a top 102, apertures 104, identifying marks 106 and projecting sides 108. The projecting sides are connected to edges 103 of the top. Although the projecting sides shown in FIG. 1 are perpendicular to the top, one of skill in the art understands that this perpendicular arrangement is not required. The projecting sides may be connected in any non-parallel or non-substantially parallel manner to the top of the sample collection container rack overlay. As a non-limiting example, the projecting sides may be connected to the edges 103 of the top in a 60 degree angle. Generally, as used herein, non-parallel and non-substantially parallel describe a manner of connecting the projecting sides to the edges in a different plane than the top. In some embodiments, this connection may be at any angle that allows the projecting sides to stabilize the sample collection rack overlay.

In the invention, the sample collection container rack overlays generally may be made of any suitable material including solvent resistant metals and plastics. In some embodiments, the sample collection container rack overlay may be made of a flexible material to ensure a snug fit on the sample collection container rack. In some embodiments, the sample collection container rack overlays could be made out of plastic such as Teflon. An advantage of Teflon would be the high solvent resistance. In some embodiments, the sample collection container rack overlays can also be made out materials such as aluminum or stainless steel. Aluminum is advantageous because of its reduced weight and because it easily accommodate bends in a press.

The top 102 of the sample collection container rack overlay normally mimics the shape of the top of the sample collection container rack for which the sample collection container rack overlay is designed. The embodiment shown in FIG. 1 demonstrates a rectangular top 102. Although in some embodiments, the rectangular top of the sample collection container rack overlays will match the sizes of previously known sample collection container racks, one of skill in the art will recognize that the top of the sample collection container rack overlays may be designed to be any shape that properly fits, according to the invention, sample collection container racks. Thus, as a non-limiting example, the sample collection container rack overlays may be triangular, square, circular, etc.

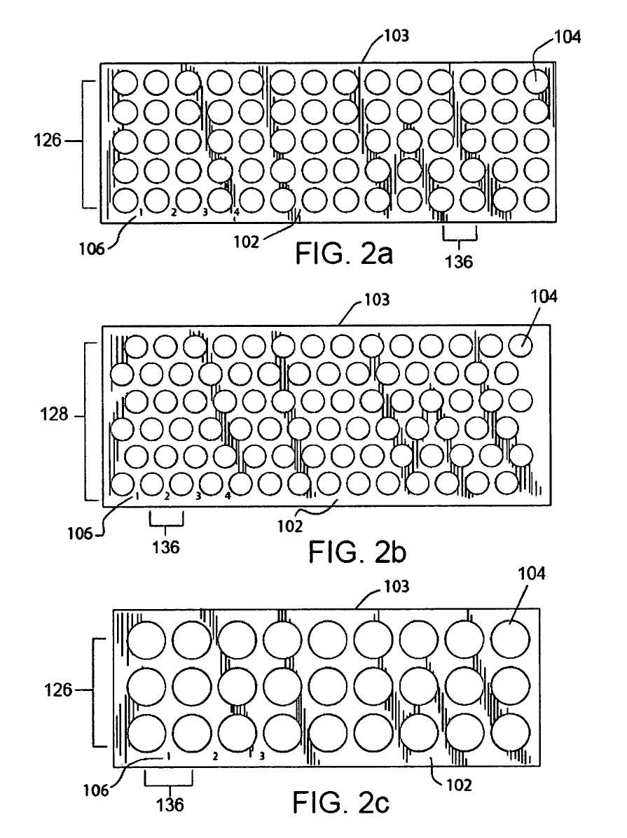

The top of the sample collection container rack overlay generally comprises a number of apertures adapted to receive sample collection containers. As used herein, a sample collection container includes any type of tube, vial, or plate capable of holding a scientific sample of interest. Referring again to the embodiment shown in FIG. 1, the apertures 104 of the sample collection container rack overlay 101 may comprise circular openings. As shown in the embodiments of FIGS. 2a-2c, these circular openings may be a variety of different sizes. One skilled in the art will recognize that the diameter size of the circular openings may vary to allow sample collection containers of any known size to be used with embodiments of the invention. As non-limiting examples, the circular openings may be adapted to receive standard sample collection containers including 0.5 milliliter (ml), 1.5 ml, and 2.0 ml microcentrifuge tubes, 10 ml, 25 ml and 50 ml centrifuge tubes, and 13 millimeter (mm), 20 mm and 30 mm test tubes. In some embodiments, the apertures of the sample collection container rack overlay may include circular openings adapted to fit culture dishes. In the embodiments shown in the figures, the apertures adapted for receiving the sample collection containers comprise circular openings, however, one of skill in the art will understand that the apertures of the sample collection container rack overlay may comprise any shape adapted to receive sample collection containers. For example, non-limiting possible alternative shapes include triangular, square, or rectangular openings.

FIGS. 2a-2c additionally demonstrates embodiments wherein the number of apertures, demonstrated by circular openings, varies. Generally the size of the sample collection container, as well as the size of the sample collection container rack on which the sample collection container rack overlay is fitted, determines the number of apertures on an individual sample collection container rack overlay. Furthermore, as shown by the embodiments in FIGS. 2a-2c, the spacing 136 of the apertures 104 can vary. For example, the spacing 136 of the apertures 104 may include both aligned 126 and offset 128 placement. As the skilled artisan understands, the present invention contemplates that the apertures in a single sample collection container rack overlay need not all be of the same shape or size.

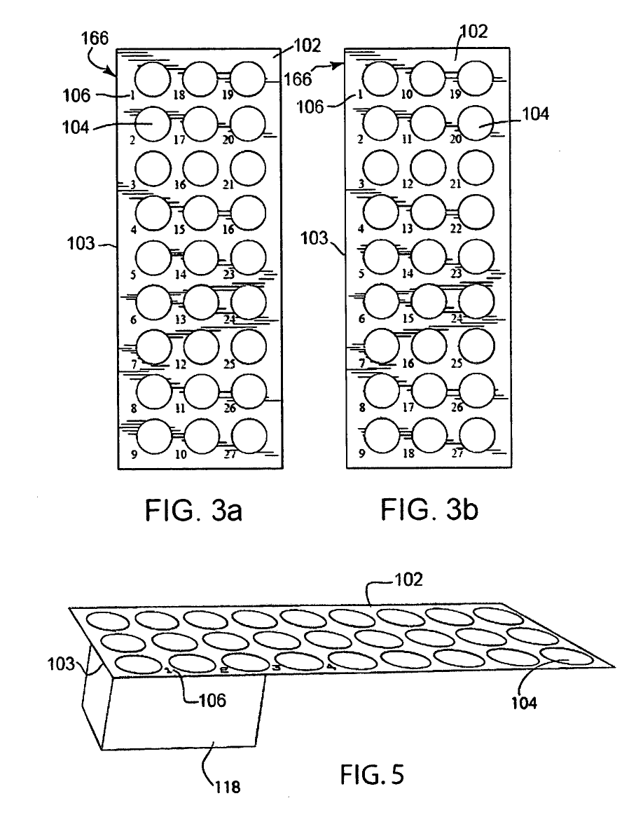

Commonly, the apertures of the sample collection container rack overlay will be identified by identifying marks. Although the embodiment in FIG. 1 demonstrates decimal numerals as the identifying marks 106, the skilled artisan understands that any type of identifying mark, including letters, roman numerals, binary numerals, and such may be used. Additionally, as long as the identifying marks distinguish specific apertures, the identifying marks may be placed at any position on the top of the sample collection container rack overlay. As shown by the embodiment demonstrated in FIG. 3a, the identifying marks may be placed on the top of the sample collection container rack overlay in a serpentine pattern. The serpentine pattern may start at the back left 166 of the top 102 of the sample collection container rack overlay, like the serpentine pattern shown in FIG. 3a, or, alternatively, the serpentine pattern may initiate at a different aperture on the top of the sample collection container rack overlay. As understood by the skilled artisan and demonstrated by the embodiment of FIG. 3b, the identifying mark pattern also may be non-serpentine. In some embodiments, patterns of the identifying marks would be serpentine or non-serpentine with starting numbering positions in front left of the sample collection container rack overlay or in other positions of the sample collection container rack overlay. As one of skill in the art understands, custom numbering sample collection container rack overlays, including, but not limited to multiple numbering sequences within an overlay are also possible.

The identifying marks on the top of the sample collection container rack overlay may be embedded in or printed on the top of the sample collection container rack overlay using any method known in the art. In some embodiments, applicable methods may include physical and chemical etching. For example, air dry epoxy ink has been demonstrated to be resistant to solvents, and thus, to perform well in a laboratory environment.

In some embodiments, in order to ensure longevity and readability, the identifying marks will be compatible with reverse-phase and normal-phase solvents, including acetonitrile, methanol, hexane, acetone, isopropyl alcohol, tetrahydrofuran, dichloromethane, and 0.1% trifluroacetic acid.

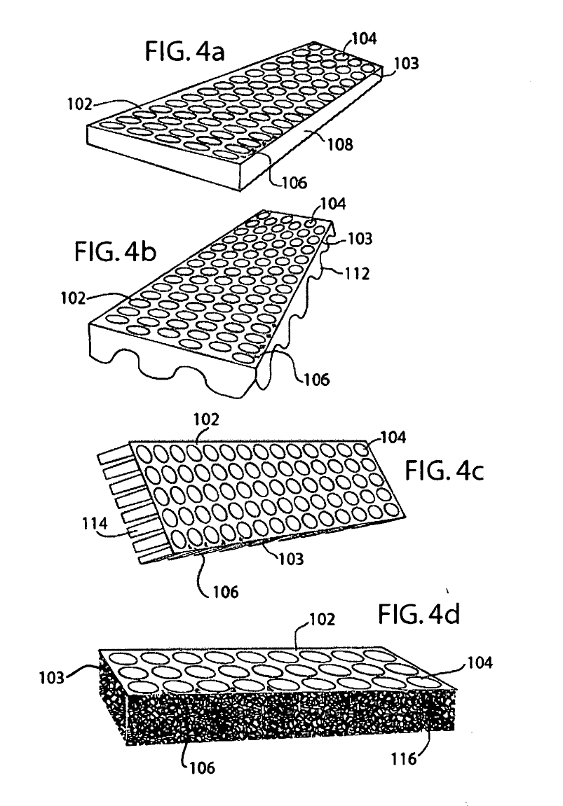

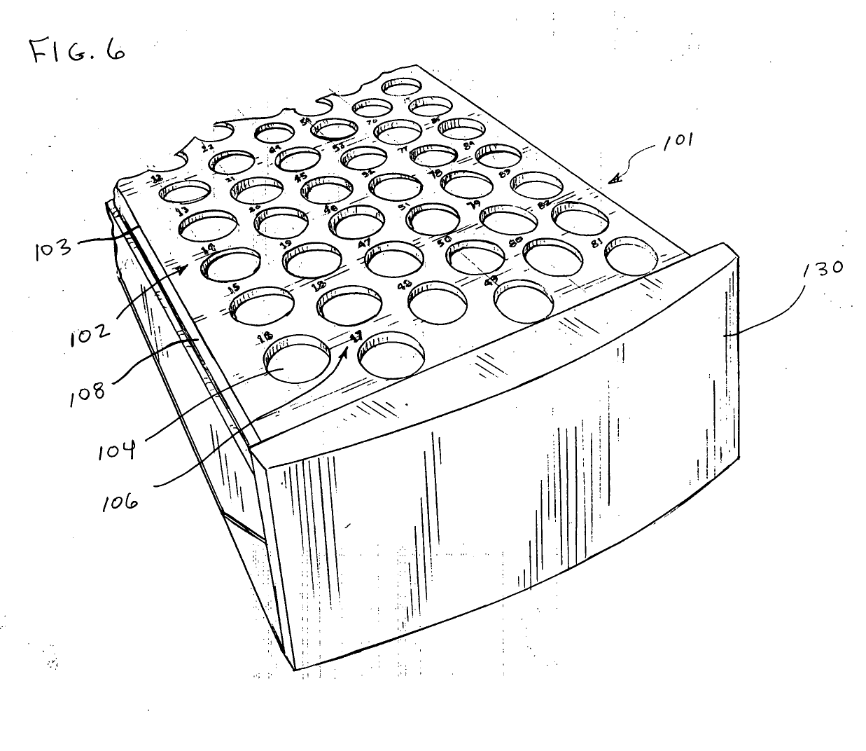

Surprisingly and unexpectedly, the addition of projecting sides to the top of the sample collection container rack overlay provided many benefits, one of the most important being increased stability. Generally, the presence of the projecting side, rather than the configuration of the projecting side, imparts the benefits. As shown in FIGS. 4a, 4b, 4c, and 4d, many projecting side configurations may be adapted to use with the sample collection container rack overlay. Specifically, the configuration of the projecting sides are not so limiting as to only encompass rectangular projecting sides, although a rectangular projecting side 110, like that demonstrated in the embodiments in FIG. 1 and FIGS. 4a-4d, may be used with the sample collection container rack overlay. Examples of other projecting side configurations include those shown in FIGS. 4b, 4c, and 4d, which encompass a curved shape 112, open bars 114, and mesh 116, respectively. In a sample collection container rack overlay having more than one projecting side, one of skill in the art will appreciate that each projecting side may be of a unique structure.

The skilled artisan also understands that the projecting side of the sample collection container rack overlay does not need to span the entire length of the top, but only needs to span enough distance to fulfill the increased stability benefit of the invention. FIG. 5 demonstrates an exemplary embodiment showing a projecting side 118 that only spans half the length of the top 102. Knurling at least a portion of one projecting side provides a grasping point for the user to easily grasp the rack overlay for placement on the rack and for removal from the rack. Grasping the knurled portion particularly facilitates removal of the rack overlay when the hand of the user is gloved as it typical in a laboratory environment.

Furthermore, in addition to variance in the length of the projecting side, it is contemplated that the depth of the projecting side may also vary. For example, embodiments of the current invention may encompass any projecting side width that continues to provide increased stability.

The at least one projecting side of the sample collection container rack overlay provides added stability when the overlay is fit on a rack used to hold sample collection containers. Although the sample collection container rack overlay may find use with many types of sample collection container racks, in one embodiment of the invention, the rack is adapted to be used with a sample collection container rack designed for use with an automated liquid handler. The sample collection container rack overlay may be especially suited for use with automated liquid handlers because of their increased stability.

Because of their time saving capabilities, automated liquid handlers, which automatically dispense a selected quantity of liquid reagent, solvent or sample, are used in a variety of laboratory procedures. Sample collection container racks adapted to be used with the automated liquid handler systems are either sold with the automated liquid handlers or sold individually for use with the automated liquid handlers. In many cases, the sample collection container racks used with automated liquid handlers are subject to movement both while on the automated liquid handler and while being moved to other machinery. Thus, a sample collection container overlay which stably remains on the sample collection container rack during movement is of the utmost importance. Embodiments of the present invention provide this added stability.

Also, certain embodiments of the sample collection container rack overlay allow advantageous matching of the identifying marks on the sample collection container rack overlay with numbered positions previously encoded in the software used with the automated liquid handler. Therefore, an additional advantage of the present invention includes an ability to adapt the identifying marks to complement known automated liquid handler software.

FIG. 6 illustrates the use of an embodiment of the sample collection container rack overlay with a sample collection container rack adapted to be used with an automated liquid handler. Generally, in the case of a sample collection container rack like that shown in FIG. 6, the sample collection container rack overlay 101 snugly fits over the top of a sample collection container rack 130 containing the same size and number of apertures 104 as the sample collection container rack overlay. However, in some embodiments, the sample collection container rack overlay may be used with sample collection container racks having either a different number and/or a different size of apertures than the sample collection container rack overlay.

In some embodiments, the at least one projecting side of the sample collecting container rack overlay comprises a fastener that fastens to the sample collection container rack. The fastener of the sample container rack overlay may comprise any fastener complementary to a sample collecting container rack, including but not limited to hooks, clamps, snaps, nuts and bolts, and screws. In some embodiments, when the sample collecting container rack is made of metal, the sample collecting container rack overlay may have magnets attached to the inside of the projecting at least one side to ensure a secure fit.

The at least one projecting side 108 of the sample collection container rack overlay prevents the sample collection container rack overlay from easily sliding off of the sample collection container rack, especially when the sample collection container rack is empty of sample collection containers. The at least one projecting side 108 also keeps the sample collection container rack overlay snugly fit to the sample collection container rack during storage and stacking of the sample collection container racks. This snug fits keeps the sample collection container rack overlay from slipping and engaging the sample collection containers. This is particularly advantageous when the sample collection containers are made of glass or are otherwise fragile. Although the size of the sample collection container rack shown in FIG. 6 involves a particular size, the skilled artisan will understand that the sample collection container rack overlays of the present invention may fit many different types of sample collection container racks.

Not only may embodiments of the invention fit sample collection container racks of differing sizes, but embodiments may also fit sample collection container racks of differing materials and differing arrangement of projecting sides. For example, if the sample collection container rack has two longer sides serving as handles to aid in moving the sample collection container rack, the sample collection container rack overlay may have two projecting sides corresponding to the sides of the sample collection container rack not serving as handles. Another example may encompass the case where the sample collection container rack has no protruding sides. In this situation, it may be advantageous to have a sample collection container rack overlay with either two or four projecting sides.

In certain embodiments, the sample collection container rack overlay may have attached handles that allow the sample collection container rack overlay to be easily taken on and off of the sample collection container rack. Still other embodiments include a portion of the projecting side that is knurled to allow quick and easy placement and removal of the rack overlay from the rack. Further to the advantage of allowing easy of removal and placement of the sample collection container rack overlay, some embodiments may have finger indentations.

Those knowledgeable in the art will appreciate that the device of the invention may also lead to numerous additional benefits and advantages. Moreover, those knowledgeable in the art will appreciate that the exemplary device of the invention shown and described herein are but exemplary embodiments, and that many equivalent and alternative embodiments exist within the scope of the invention. Accordingly, discussion made herein should not be interpreted as a limitation of the scope of the claimed invention.

While preferred embodiments have been illustrated and described, it should be understood that changes and modifications can be made therein in accordance with ordinary skill in the art without departing from the invention in its broader aspects as defined in the following claims.

1. A device for identifying sample collection containers in a sample collection container rack, the device comprising:
a. a top comprising at least one aperture and at least one edge, wherein the aperture is adapted to receive a sample collection container;
b. at least one identifying mark positioned on the top, wherein the at least one identifying mark identifies the aperture; and
c. at least one projecting side connected to the at least one edge in a non-substantially parallel manner to the top, wherein the top and the at least one projecting side are adapted to overlay a sample collection container rack.

2. The device of claim 1, wherein the at least one identifying mark comprises at least one number.

3. The device of claim 2, wherein the at least one number comprises a set of numbers.

4. The device of claim 3, wherein the set of numbers comprises numbers arranged in a serpentine pattern.

5. The device of claim 4, wherein the numbers arranged in the serpentine pattern are sequential.

6. The device of claim 3, wherein the set of numbers comprises numbers arranged in a non-serpentine pattern.

7. The device of claim 6, wherein the numbers arranged in the non-serpentine pattern are sequential.

8. The device of claim 1, wherein the at least one identifying mark is resistant to acetonitrile, methanol, hexane, acetone, isopropyl alcohol, tetrahydrofuran, dichloromethane, and 0.1% trifluroacetic acid.

9. The device of claim 1, wherein the at least one identifying mark is made of epoxy ink.

10. The device of claim 1, wherein the apertures comprise circular openings.

11. The device of claim 10, wherein the circular openings are adapted to receive microcentrifuge tubes.

12. The device of claim 1, wherein the apertures comprise the same shape.

13. The device of claim 1, comprising two projecting sides connected to the top.

14. The device of claim 1, comprising four projecting sides connected to the top.

15. A device for identifying sample collection containers in a sample collection container rack comprising:
a. a sample collection container rack, and
b. a sample collection container rack overlay, wherein the sample collection container rack overlay comprises
i. a top comprising at least one aperture and at least one edge, wherein the aperture is adapted to receive a sample collection container;
ii. at least one identifying mark positioned on the top, wherein the at least one identifying mark identifies the aperture; and
iii. at least one projecting side connected to the at least one edge in a non-substantially parallel manner to the top, wherein the top and at least one projecting side overlay the sample collection container rack.

16. The device of claim 15, wherein the sample collection container rack is adapted for use with an automated liquid handler.

17. A device for identifying sample collection containers in a sample collection container rack comprising:
a. an automated liquid handler, comprising
i. a bed;
b. a sample collection container rack, wherein the sample collection container rack sits on the bed of the automated liquid handler; and
c. a sample collection container rack overlay, wherein the sample collection container rack overlay comprises
i. a top comprising at least one aperture and at least one edge, wherein the aperture is adapted to receive a sample collection container;
ii. at least one identifying mark positioned on the top, wherein the at least one identifying mark identifies the aperture; and
iii. at least one projecting side connected to the at least one edge in a non-substantially parallel manner to the top, wherein the top and at least one projecting side overlay the sample collection container rack.
